(19) United States
(12) Patent Application Publication
(10) Pub. No.: US 2018/0350061 A1
(43) Pub. Date: Dec. 6, 2018

(54) Apparatus and Method for Terminating and Testing Connectors

(71) Applicant: Panduit Corp., Tinley Park, IL (US)

(72) Inventors: Richard J. Pimpinella, Frankfort, IL (US); Jose M. Castro, Naperville, IL (US); Yu Huang, Orland Park, IL (US); Bulent Kose, Burr Ridge, IL (US)

(73) Assignee: Panduit Corp., Tinley Park, IL (US)

(21) Appl. No.: 16/055,923

(22) Filed: Aug. 6, 2018

Related U.S. Application Data
(63) Continuation of application No. 14/920,270, filed on Oct. 22, 2015.
(60) Provisional application No. 62/077,433, filed on Nov. 10, 2014.

(51) Int. Cl. G06T 7/00; H04N 5/225; G02B 6/38; G01M 11/00

(52) U.S. Cl. CPC G06T 7/0004; H04N 5/2256; G02B 6/3846; G06T 2207/30108; G01M 11/35; G01M 11/37; G02B 6/3801

(57) ABSTRACT

At least some embodiments of the present invention relate to the field of optical fiber splicing and the evaluation of resulting splice joints. In an embodiment, the present invention is an apparatus for evaluating the integrity of a mechanical splice joint, and comprises a light source, digital video camera, digital signal processor, and visual indicator, wherein the apparatus connects to the test connector and the digital signal processor analyzes digital images of the scatter light from at least a portion of the test connector.

### CROSS-REFERENCE TO RELATED APPLICATIONS

This application is a continuation of U.S. patent application Ser. No. 14/920,270, filed Oct. 22, 2015; which claims the benefit of U.S. Provisional Patent Application No. 62/077,433 filed on Nov. 10, 2014, which is incorporated herein by reference in its entirety.

### FIELD OF INVENTION

The present invention generally relates to the field of optical fiber splicing, and more specifically, to apparatuses and methods directed to mechanical splice termination and evaluation of resulting splice joints.

### BACKGROUND

When working in the field of fiber optics, users are often required to establish connections between non-connectorized ends of optical fibers or fiber ribbons. This is generally referred to as splicing and typically involves creating temporary or permanent joints between two (or sometimes more) fibers. In certain instances, the two fibers are precisely aligned and then fused together using localized intense heat often times created with an electric arc. This is referred to as fusion splicing and is widely employed to create high performance permanent joints between two optical fibers. However, a fusion splicer apparatus can be bulky, expensive, and relatively fragile. Alternatively, the two fibers may simply abut one another in an alignment fixture often referred to as a mechanical splice. The alignment fixture may be an alignment tube or V-groove which receives two ends of separate fibers on either side and has the means to physically secure the fibers. In other instances, the alignment device may be a fiber optic connector with a stub fiber embedded therein made to be connectorized to a field fiber. In this case the field fiber can be terminated utilizing a mechanical splice to the stub fiber inside the connector. An example of the fiber optic connector with an embedded stub fiber is illustrated in FIG. 1.

To avoid loss of signal and reduce the potential reflectance or light leakage within these joints, users must ensure that the fiber(s) are properly cleaved, that there is precise alignment between the fibers, and that transparent gel or optical adhesive applied between the fibers matches the optical properties of the glass. However, these details are not always easy to detect and/or ensure. Therefore, there is a continued need for apparatuses and methods directed towards helping to determine and improve the quality of mechanical splices and provide improved termination of fibers such as field fibers.

### SUMMARY

Accordingly, at least some embodiments of the present invention are generally directed towards helping to determine and improve the quality of mechanical splices of optical fibers, and provide methods and apparatuses to assist in fiber termination.

In an embodiment, the present invention is an apparatus for evaluating the integrity of a mechanical splice joint, and comprises a light source, digital video camera, digital signal processor, and visual indicator, wherein the apparatus connects to the test connector and the digital signal processor analyzes digital images of the scatter light from at least a portion of the test connector.

In another embodiment, an apparatus according to the present invention includes a Bluetooth or other wireless communication interface to enable communication to a portable or handheld device such as a smartphone, wherein the portable device contains a resident application for providing a user interface to said apparatus and may also include splice analysis software and/or firmware.

In yet another embodiment, the present invention is a method for evaluating the integrity of a mechanical splice joint, wherein the method includes the steps of coupling light into a test connector and a field fiber, and, evaluating digital images of a scattered light pattern from at least a portion of the mechanical splice joint and the optical fibers.

In still yet another embodiment, the present invention is an apparatus for installing a field fiber in a fiber optic connector having a stub fiber therein and/or evaluating at least one characteristic of a splice between the stub fiber and the field fiber, at least a portion of the fiber optic connector being at least one of transparent or translucent. The apparatus includes a light source, the light source injecting a light into the fiber optic connector via the stub fiber, some of the injected light radiating through the fiber optic connector. The apparatus also includes a digital camera, the digital camera capturing a digital image of the fiber optic connector. Additionally, the apparatus includes a digital processor, the digital processor using the digital image to evaluate light radiating through the fiber optic connector to determine the at least one characteristic of the splice.

In still yet another embodiment, the present invention is a method of installing a field fiber in a fiber optic connector having a stub fiber therein and/or evaluating at least one characteristic of a splice between said stub fiber and said field fiber, at least a portion of said fiber optic connector being at least one of transparent or translucent. The method includes the steps of: (i) mating said fiber optic connector with a test apparatus; (ii) injecting a light from a light source into said fiber optic connector via said stub fiber, some of said injected light radiating through said fiber optic connector; and (iii) using a digital camera to evaluate light radiating through said fiber optic connector to determine said at least one characteristic of said splice.

These and other features, aspects, and advantages of the present invention will become better understood with reference to the following drawings, description, and any claims that may follow.

### BRIEF DESCRIPTION OF THE DRAWINGS

FIG. 1 illustrates a side cut-away view of a field terminated fiber optic connector with a stub fiber.

FIG. 2 illustrates a side cut-away view of an embodiment of the present invention.

FIG. 3 illustrates a flow chart representing a method for terminating a field fiber according to an embodiment of the present invention.

FIG. 4 illustrates a negative of a digital image of test connector with a light source turned on and a field fiber partially inserted.

FIGS. 5A-5L illustrate negative digital images of exemplary field fiber and stub fiber connector terminations.

FIG. 6 illustrates a flow chart representing a method for terminating a field fiber according to an embodiment of the present invention.

FIGS. 7A-7L illustrate negative digital images of the connectors shown in FIGS. 5A-5L, respectively, converted to bit level patterns.

FIGS. 8A-8L illustrate various parameters for the connectors shown in digital images of FIGS. 7A-7L, respectively.

FIGS. 9A-9C illustrate metrics R1, R2, and Uₘ, respectively as a function of insertion loss for test connector evaluation.

### DETAILED DESCRIPTION

As used herein, the term “metric” shall be understood to mean any mathematical relationship which represents the behavior or optical radiation at any desired point or any desired collection of points within a particular fiber optic connector as it relates to the connector's insertion loss. In at least some embodiments of the present invention, the selected metrics have a relatively high correlation to the connector's insertion loss. Furthermore, for the sake of convenience and ease of visualization, digital images reproduced herein have been presented as negatives rather than positives.

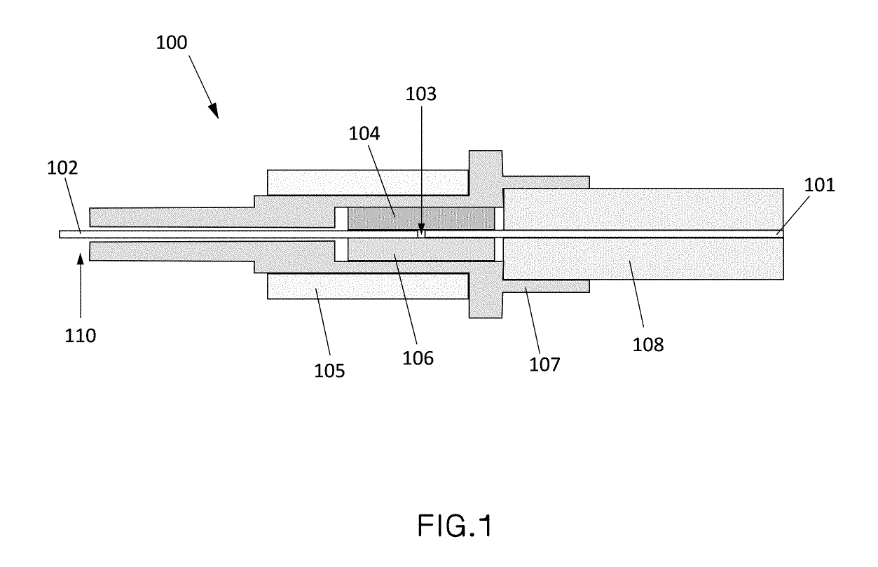

Mechanical splicing can occur when a field optical fiber is connectorized to a pre-manufactured fiber optic connector with a stub fiber embedded therein. The particular example of FIG. 1 shows a re-terminable connector similar to Panduit's OPTICAM® pre-polished fiber connectors. Connector 100 generally includes a ferrule holder 107 with a ferrule 108 positioned at the front end thereof, and top and bottom planks 104, 106 positioned between the ferrule 108 and a distal end 110 of the connector. The connector 100 also includes a stub fiber 101 which is typically embedded in the optical connector at the time of manufacture. The stub fiber 101 extends from the outer edge of the ferrule (which can later interface a corresponding adapter) to the inner portion of the connector in the general area of the top and bottom planks 104, 106. At least some parts of the test connector can be made from any transparent, semi-transparent, or translucent material. To splice the stub fiber 101 with a field fiber 102, a user inserts the field fiber into the connector 100 through its distal end 110, aligns both fibers accordingly, and activates a cam 105 to clamp the field fiber and the stub fiber in place, forming a stub fiber/field fiber interface 103 (also referred to as a splice joint). Ensuring that light leakage and reflection are reduced or minimized at these joints can be essential for a well-executed splice.

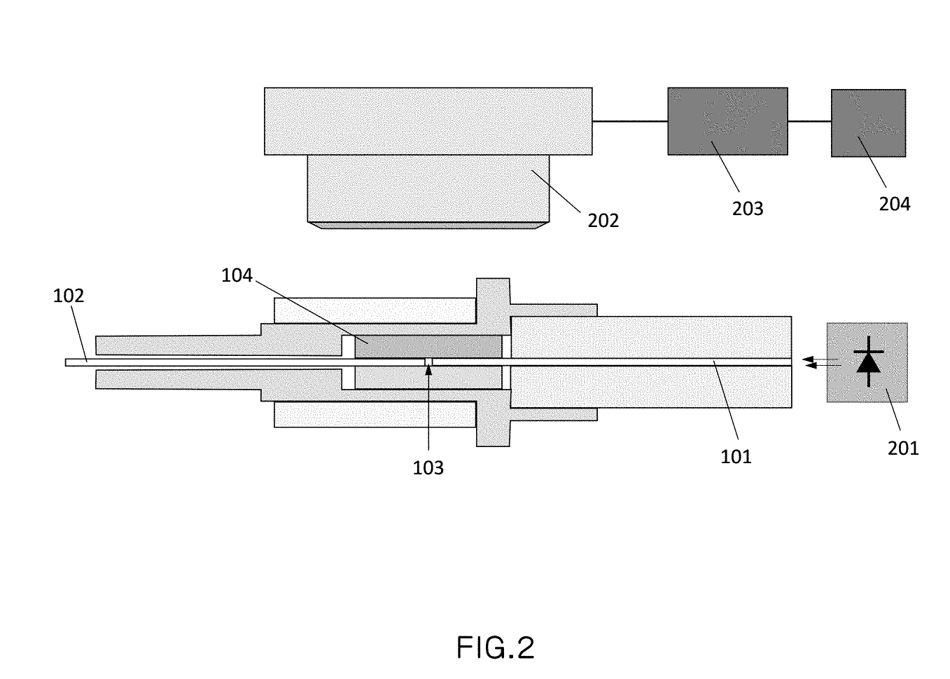

At least some embodiments of the present invention provide a means of determining and improving the quality of mechanical splices as utilized in pre-polished fiber optic connectors for terminating single-mode and multimode optical fibers in the field. One such embodiment (shown in FIG. 2) is a termination and test apparatus which comprises a light source 201, a camera 202 (e.g., a digital photo/video camera), a digital processor 203, and a pass/fail indicator and/or user interface 204.

This apparatus can aid in joining a prepared field fiber 102 to a stub fiber inside a test connector 100. To use said apparatus, the test connector 100 is positioned such that splice joint 103 is located approximately within the central field of view of the digital video camera 202. Light source 201 includes a semiconductor laser (or any other suitable optical radiation generation source) capable of emitting light having a spectral range within the optical sensitivity of the video camera, typically between about 400 nm and about 1700 nm. The light source is capable of launching light into the stub fiber when engaged with the test connector.

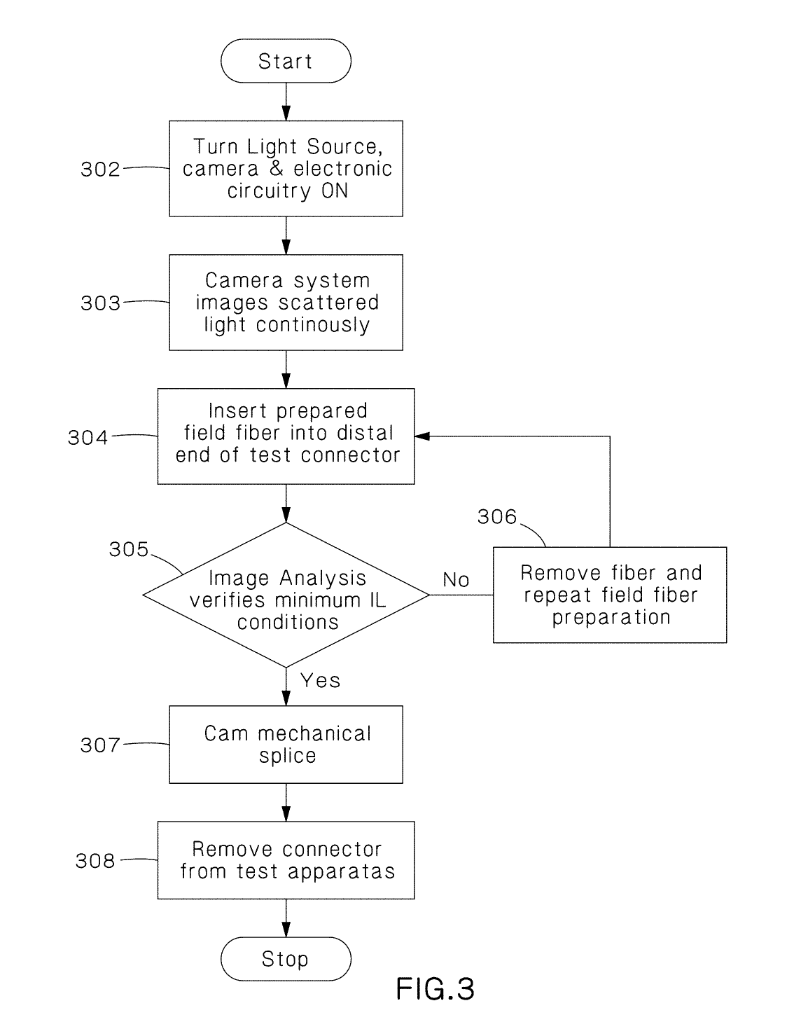

FIG. 3 illustrates a flow chart representative of a method of terminating a field fiber to a test connector and using the termination and test apparatus in accordance with an embodiment of the present invention. When the user turns on 302 the device, power is supplied to all necessary power-consuming components such as, but not limited to, the light source 201, digital video camera 202, digital processor 203, and user visual interface 204. The spatial pattern of the scattered light emanating from splice joint 103 is imaged 303 by video camera 202, and upon insertion 304 of the field fiber 102 into the test connector 100 the termination and test apparatus analyzes 305 the images by utilizing digital signal processing algorithms. If the analysis 305 yields an unsatisfactory result (which in the case of FIG. 3 is based on a minimum amount of insertion loss [IL]), steps 304 and 305 are repeated with the field fiber 102 being removed, re-prepared, and/or repositioned 306 prior to the repetition of the steps. If the analysis 305 yields a satisfactory result, the test connector 100 is cammed 308 (or secured via any other suitable means if a non-camming connector is used) and the connectorized connector 100 is then removed 309 from the test apparatus.

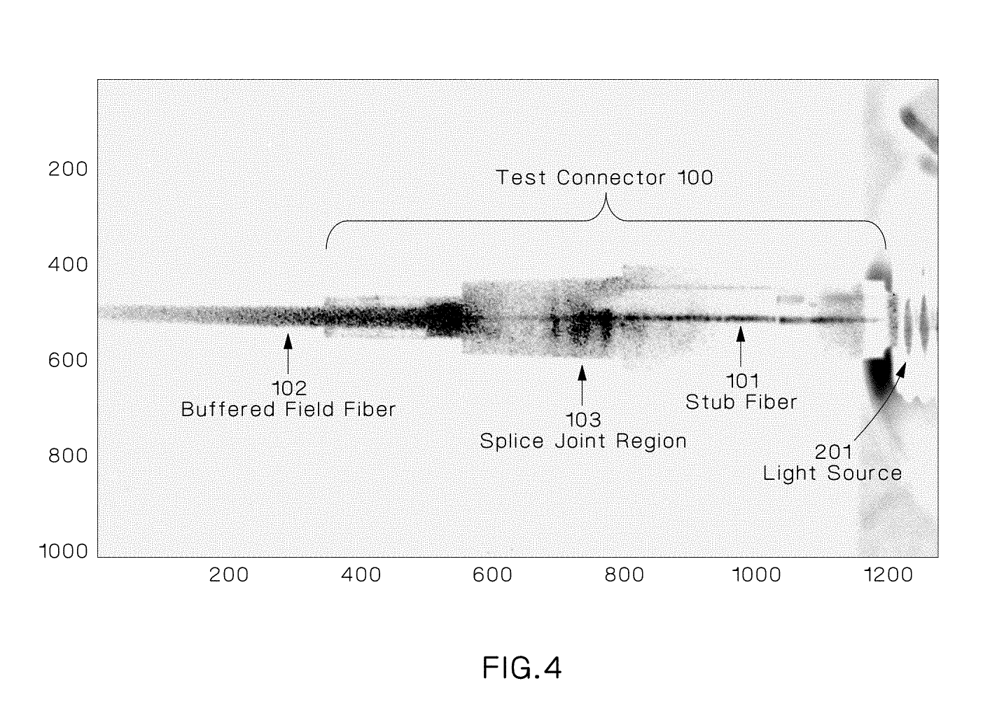

During and after the installation of the field fiber 102 into the optical fiber mechanical splice joint of the test connector 100, the apparatus continuously captures images of the scattered light pattern and analyses the digital images from at least two regions of the test connector which include, but are not limited to, splice joint 103 and the buffered field fiber 102. An example of a digital image for a partially inserted field fiber is shown in FIG. 4.

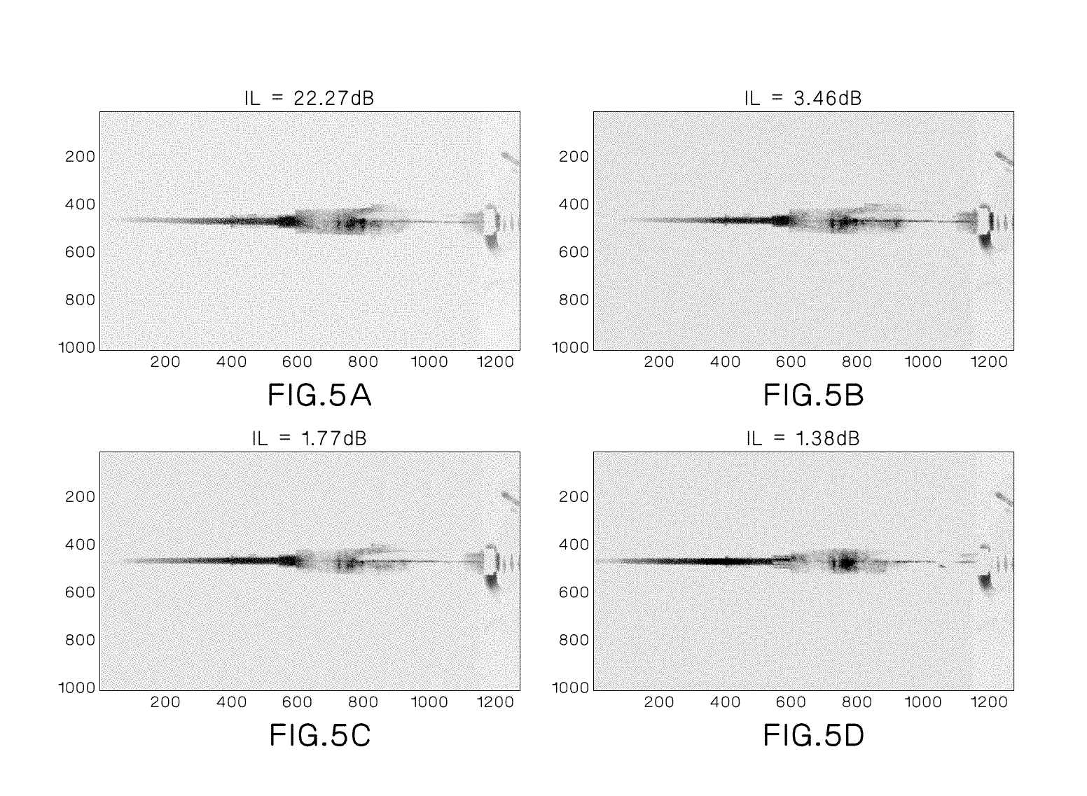

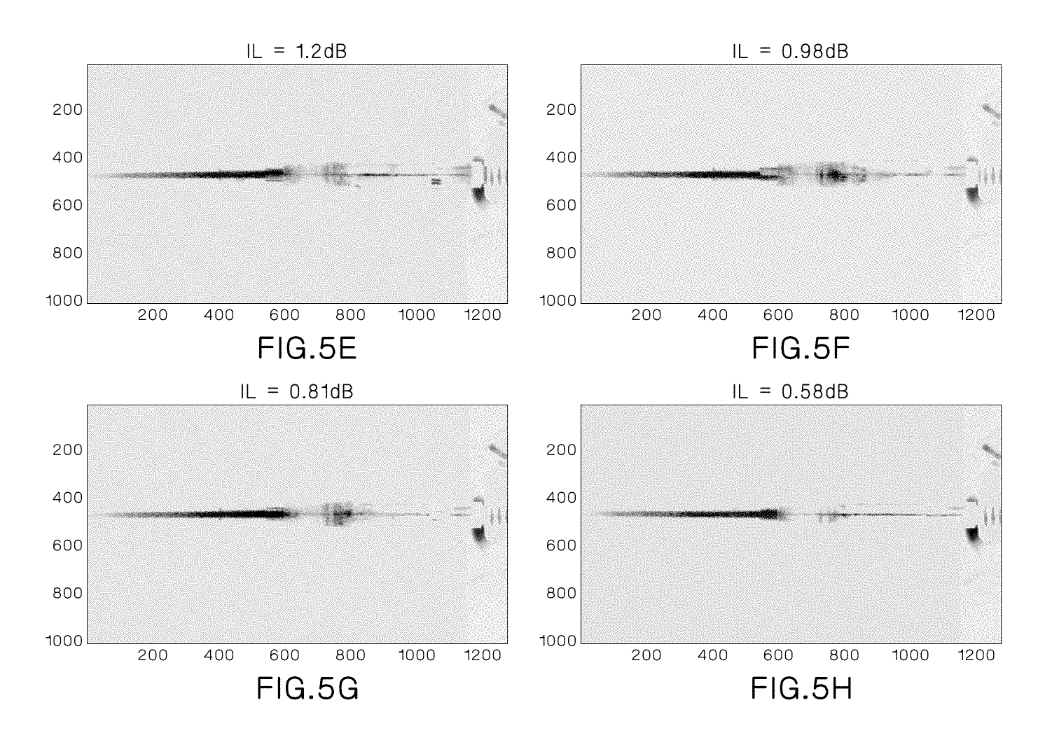

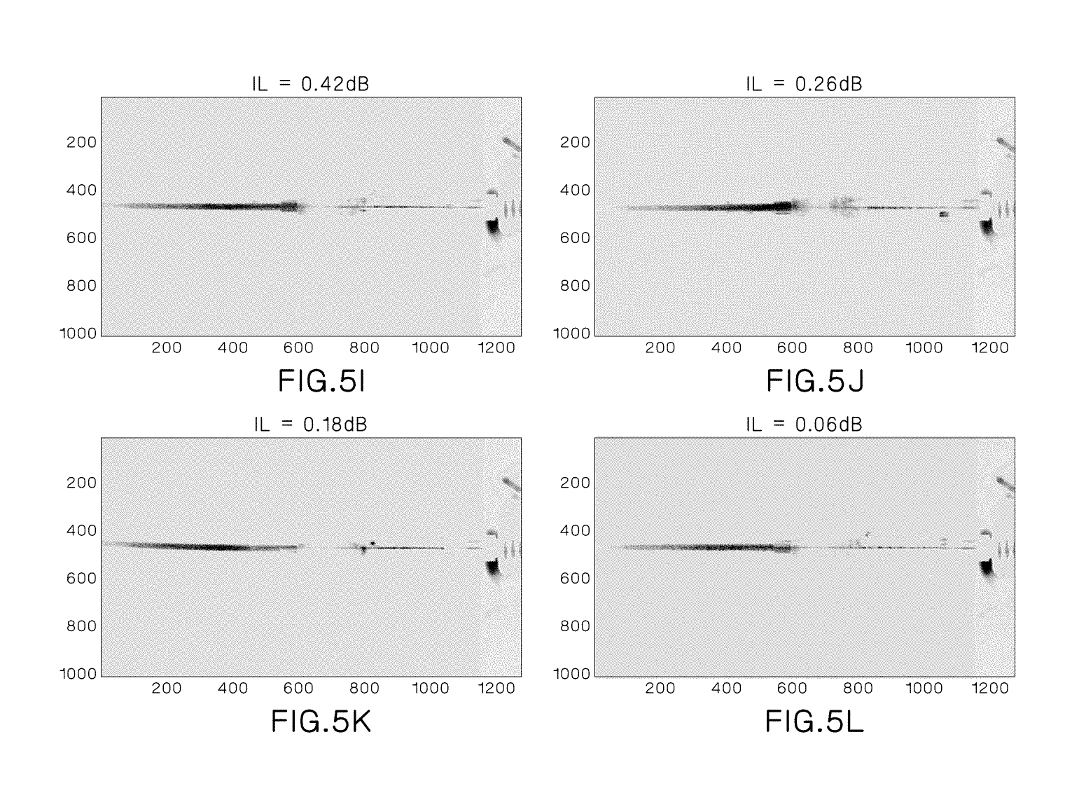

FIGS. 5A-5L show a series of negatives of digital images for an exemplary field fiber and stub fiber connector as a field fiber is installed. On the top of each image the computed insertion loss (IL) for a source wavelength of 1300 nm is indicated.

It has been observed that the optical power radiated from the stub fiber connectors may not be an accurate metric to characterize the IL. Due to variations during the connectorization, the power reaching the photodetector from multiple connector regions can suffer significant fluctuations. Accordingly, at least some embodiments of the present invention rely on the geometry of the radiated light as it travels through and scatters from the connector 100 to determine quality of a splice joint.

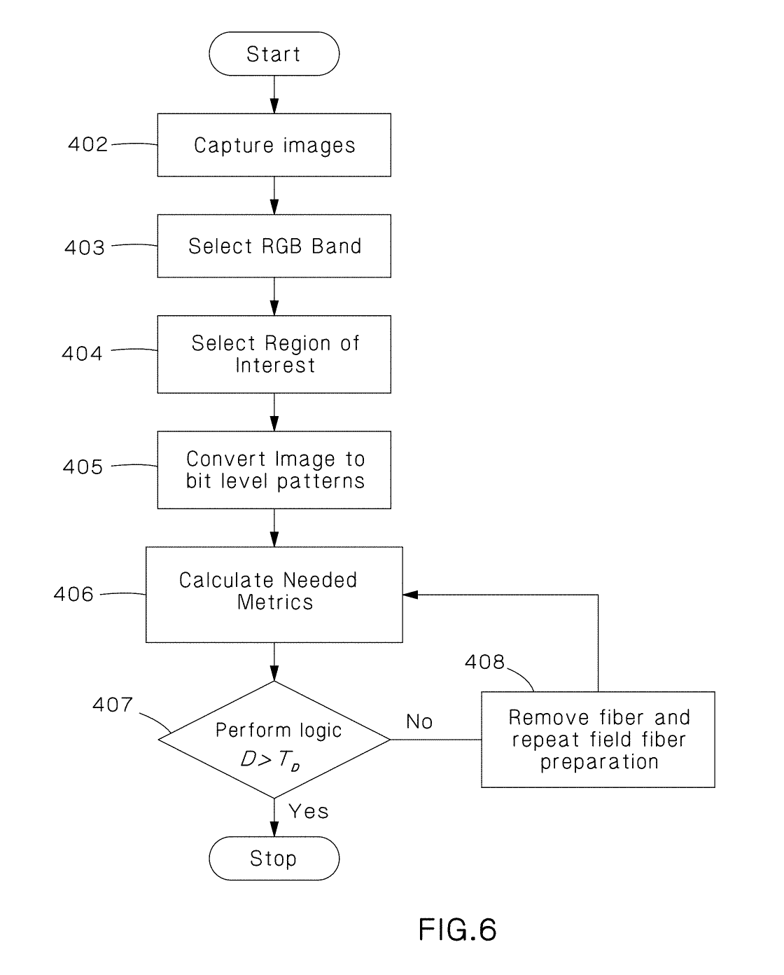

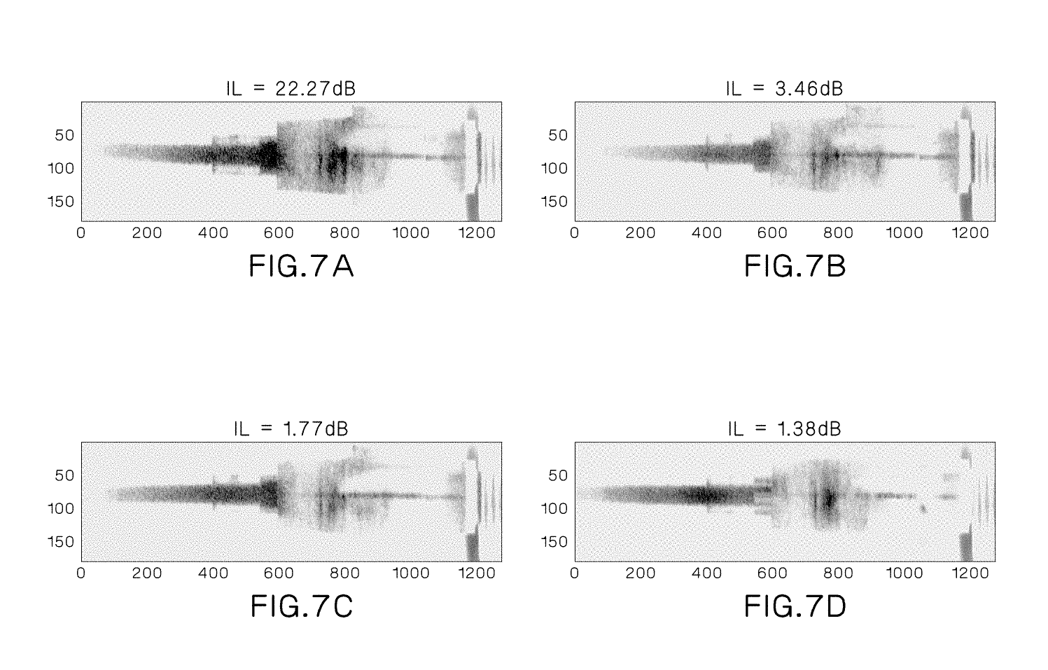

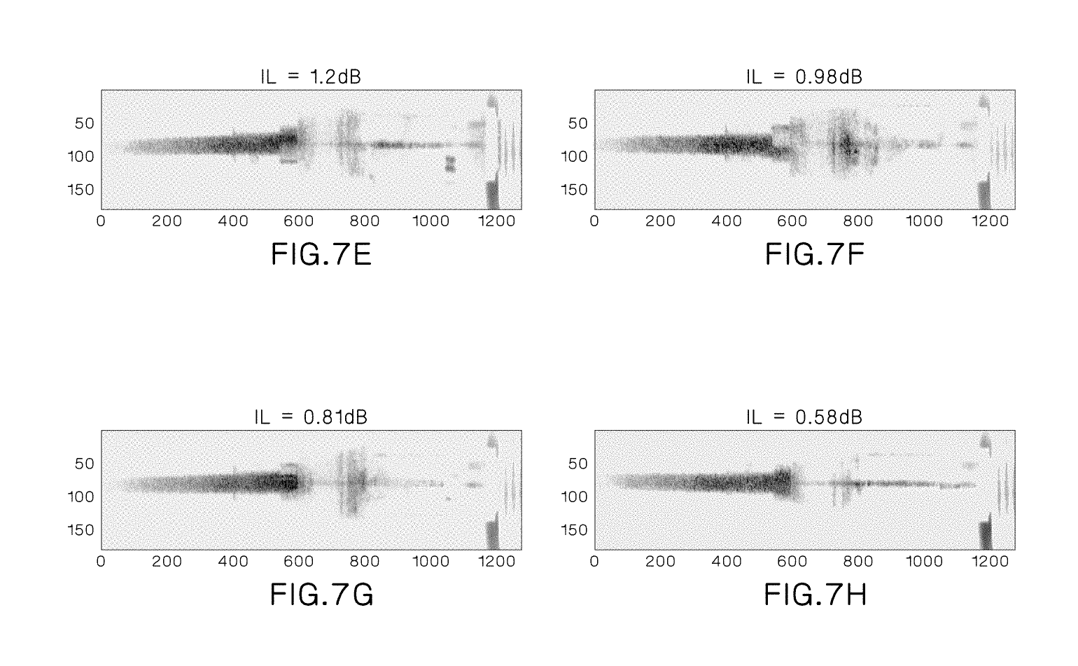

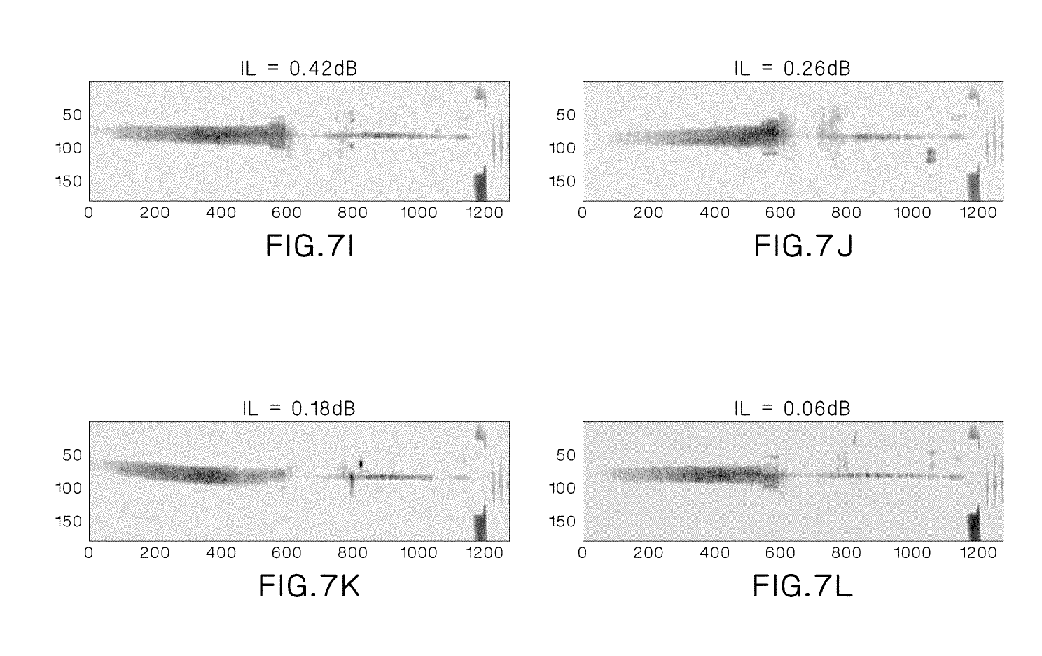

FIG. 6 illustrates a flow chart representative of one embodiment of a method according to the present invention of analyzing the captured images of the test connector and thereby analyzing the resulting splice joint. Note that while feedback may be provided to the user in real-time, the actual analysis of a splice joint is performed on a single image captured at any one moment in time. Accordingly, images captured and analyzed seamlessly may appear as though the results of the analysis are being provided in real-time. Upon capturing 402 a digital image, the image is stored in an array ima(x,y), where x and y represent the horizontal and vertical coordinates of the image pixels, respectively, and the value ima represents the relative intensity of the light hitting the respective pixel. If a color camera is used the intensity and color information can be obtained using a weighted sum of the three primary colors as shown in step 403. In step 404 the regions or “zones” of interest are selected. Typically, these zones of interest could include the field fiber 102, the splice joint region 103, and the stub fiber 101, and each zone can be represented by a respective range of pixels where each of those regions falls into. Next, the imaged pixels are converted 405 to bit level patterns. These patterns can have the background noise subtracted using, for example, the following equation:

$${ima}_{p} ( x , y ) = \frac{ima ( x , y ) - min ( ima ( x , y ) )}{max ( ima ( x , y ) ) - min ( ima ( x , y ) )} \qquad ( 1 )$$

where in the presently described embodiment min(ima(x,y)) is 2 and max(ima(x,y)) is 154. FIGS. 7A-7L show examples of images 5A-5L, respectively, after they have been converted to bit level patterns.

Next the metric parameters and ratios of selected zones are computed 406. For example an image profile can be described by equation (2), the centroid of the image can be described by equation (3), and the uniformity around the centroid can be described by equation (4).

$$\begin{matrix}S ( x ) = {\sum }_{ypixel} {ima}_{p} ( x , y ) & ( 2 ) \\ C ( x ) = \frac{{\sum }_{ypixels} x {ima}_{p} ( x , y )}{{\sum }_{ypixels} {ima}_{p} ( x , y )} & ( 3 ) \\ U ( x ) = \sqrt{\frac{{\sum }_{ypixels} {( x - C ( x ) )}^{2} {ima}_{p} ( x , y )}{{\sum }_{ypixels} {ima}_{p} ( x , y )}} & ( 4 )\end{matrix}$$

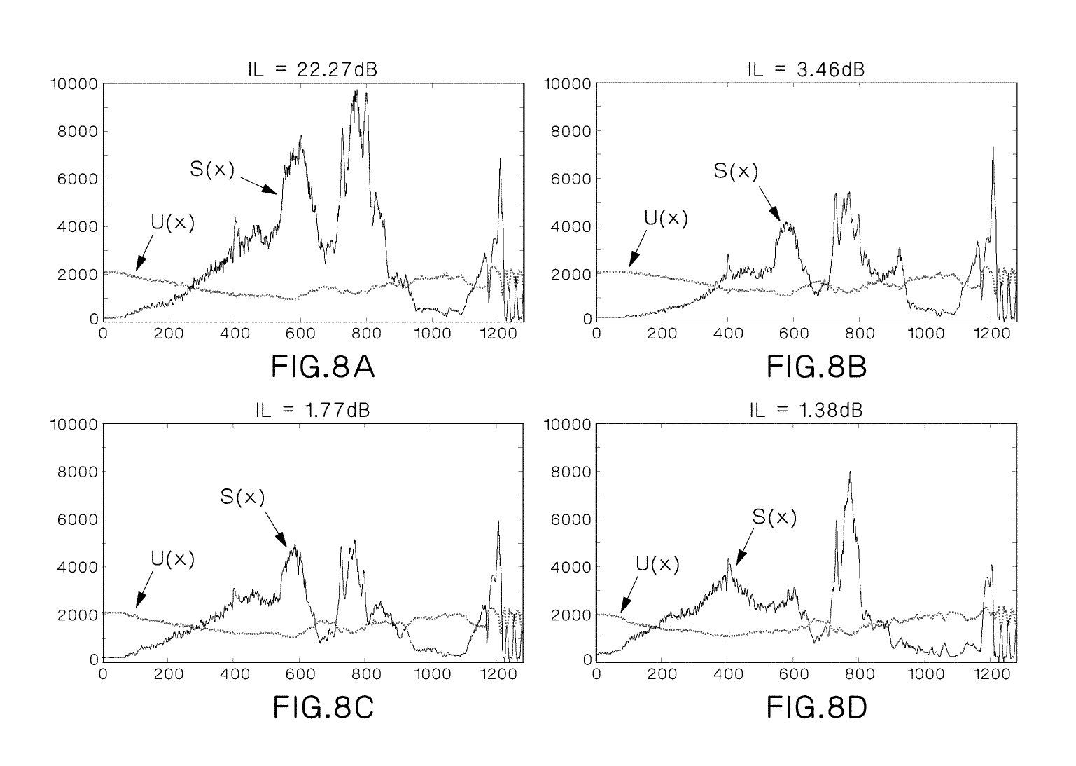

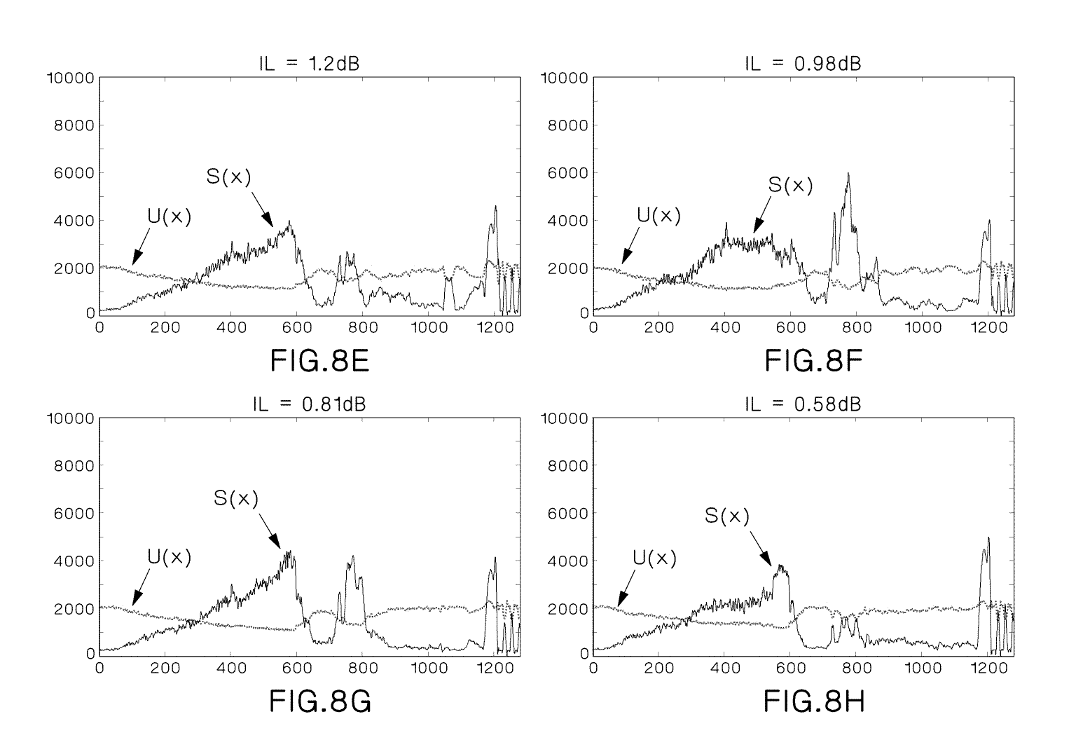

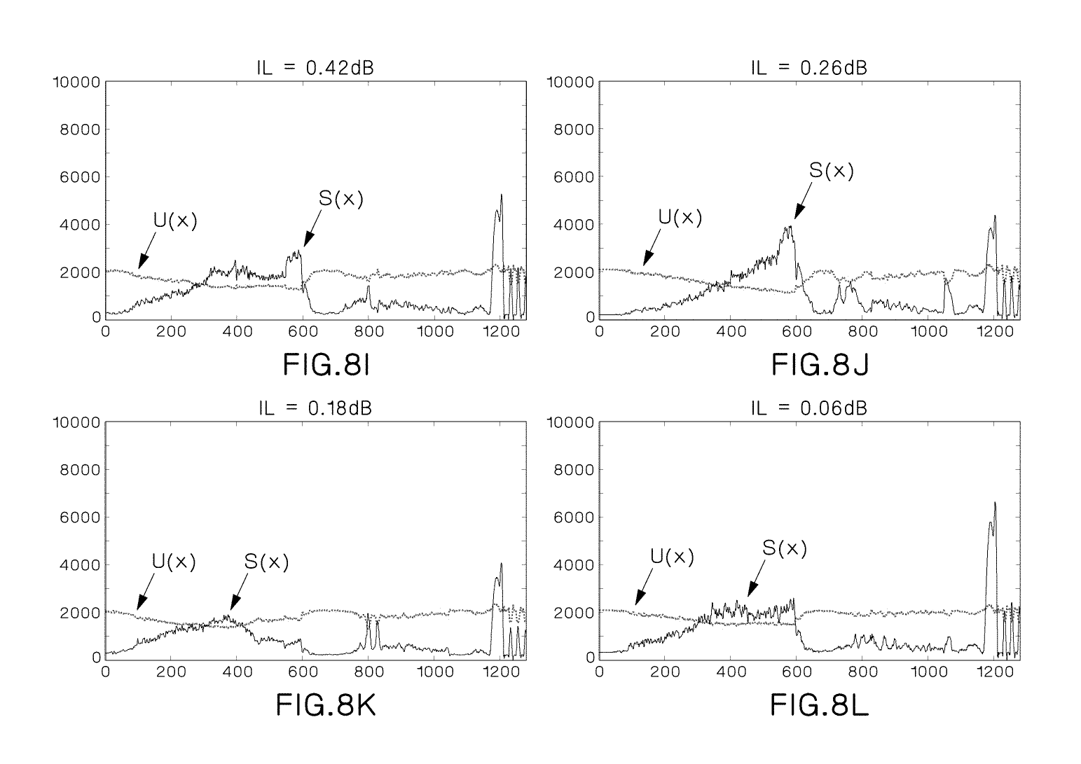

By integrating the relative optical radiation at each horizontal pixel along the connector, the image profiles give an indication of the leaking light from different locations of the connector. The centroid and uniformity (i.e., standard deviation of pixels) give an indication of how the test connector's geometry and material properties affects the leaking light. Furthermore, since various types of connectors have various types of light leakage profiles, by comparing to known profiles, the uniformity of the pixels, U(x), described in equation (4) can also be utilized to identify connector types and/or improve the location of the zones of interest. Equations (2)-(4) are just examples of various parameters that can be computed to characterize the image. For the images of FIGS. 7A-7L, the parameters S(x) and U(x) are plotted in FIGS. 8A-8L, respectively, where S(x) is plotted as a solid line and U(x) is plotted as a dotted line.

To determine the quality of the splice, one can compare specific zones of the test connector (for example as defined in FIG. 4), where the field fiber 102, the splice joint region 103, and the stub fiber 101 correspond to the pixels 200±150, 580±190, and 750±50, respectively, in the images of FIGS. 7A-7L. Note that the pixels referenced in this case are those along the horizontal axis as that is the axis along which the light source is launching light into the stub fiber. The comparison of these zones can be done using ratios which are relative metrics which, in the currently described embodiment, are computed using S(x) and/or U(x) values. The range of pixels which define the various zones are specific to the image setup parameters such as focal length of the lens, working distance from the camera, and shape of the connector. Since all this information is generally known at priori, the method described herein can be calibrated to operate efficiently.

FIGS. 8A-8L illustrate plots of computed S(x) and U(x) values for test connectors imaged in FIGS. 7A-7L respectively. It can be observed therefrom that S(x) profiles change significantly as a function of the insertion loss. For this example, one may assume that the maximum insertion loss (ILₘₐₓ) specified for the test connector is 0.5 dB. To determine whether IL≤ILₘₐₓ, one may use two ratios R₁ and R₂ defined in equations (5) and (6), respectively, to compare image zones 101, 102, and 103, and Uₘ defined in equation (7), which is the mean value of U(x) in zone 103:

$$\begin{matrix}{R}_{1} = \frac{{\sum }_{[ Region\_ 103 ]} S ( x )}{{\sum }_{[ Region\_ 102 ]} S ( x )} & ( 5 ) \\ {R}_{2} = \frac{{\sum }_{[ Region\_ 103 ]} S ( x )}{{\sum }_{[ Region\_ 101 ]} S ( x )} & ( 6 ) \\ {U}_{m} = K {mean}_{Region\_ 103} ( U ( x ) ) & ( 7 )\end{matrix}$$

where K is an optional arbitrary constant, with value of 40 in this example for normalization purposes.

The selection of the metrics can depend on the connector type and imaging setup. For the connector and setup utilized in the currently described embodiment, ratio R₁ compares the splice joint region 103 to the field fiber region 102, and ratio R₂ compares the splice joint region 103 to stub fiber region 101.

The metric values are evaluated against predetermined limits. These limits may be selected such that any particular metric falling within the established limit is deemed to signify an acceptably high probability that the insertion loss for a particular connector is less than or equal to a preferred level. Performance data which may be helpful in determining an accurate limit may be obtained by way of statistical analysis of various test connector configurations.

Since the degree of probability may be user-dependent, the predetermined limits may vary causing the system to be more or less stringent. In the presently described embodiment, metrics R₁, R₂, and Uₘ are evaluated against limits L1, L2, and L3, respectively. Accordingly, L1, L2, and L3 have been selected such that any respective R₁, R₂, and Uₘ values which fall within those limits will indicate a sufficiently high probability that the insertion loss for the test connector is ≤0.5 dB. Note that inclusion within a limit depends not only on whether a metric value is above or below some limit value, but also on whether the particular limit is an upper or a lower limit. This will vary for different metrics. In the currently described embodiment, R₁ and R₂ are upper limits and Uₘ is a lower limit. Thus, R₁<L1, R₂<L2, and Uₘ>L3 satisfy these limits.

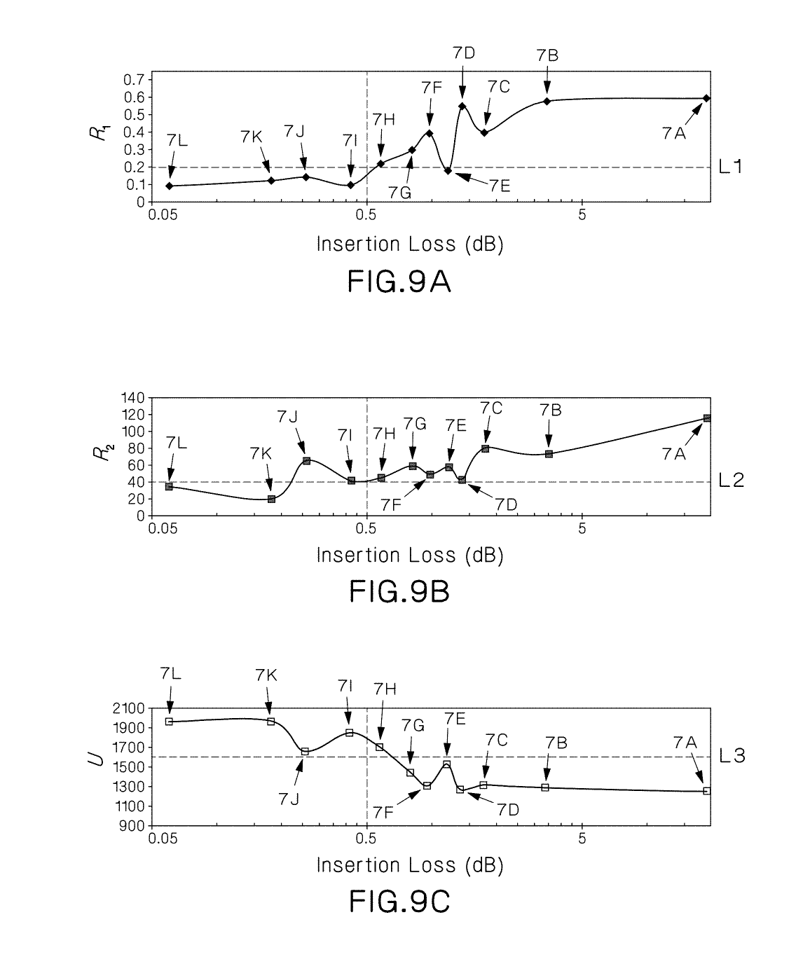

The values of R₁, R₂, and Uₘ, (along with their respective predetermined limits L1, L2, and L3) for the connectors tested in FIGS. 7A-7L are shown in FIGS. 9A-9C. From these figures it can be seen that since each metric exhibits significant variation throughout a broad range of test connector scenarios, the use of only one metric may be insufficient for formulating a decision based on some acceptable level of certainty. For example, in FIG. 9A, the R₁ value for the connector of FIG. 7E falls slightly below the upper limit set by L1, signifying an acceptable termination if relying solely on the R₁ metric. However, this would be a false positive as the actual insertion loss for this connector is 1.2 dB. To reduce the chance of a potential false-positive or a false-negative, it is advantageous to evaluate a connector based on at least two of its metrics. For example, in the presently described embodiment, any one value of R₁ (shown in FIG. 9A) may be evaluated in conjunction with, for example, a corresponding value of R₂ (shown in FIG. 9B) and/or a corresponding value of Uₘ (shown in FIG. 9C). Continuing with the example of the connector of FIG. 7E, it can be seen in either of FIG. 9B or 9C, that the R₂ and the Uₘ values for said connector fall outside of the allowed limits of L2 and L3, respectively. Accordingly, taking more than one metric into consideration may improve the accuracy of the final result of the test apparatus.

Referring back to FIG. 6, upon determining 406 the necessary metrics, assessments of those metrics are performed 407. This can be done by logically evaluating whether any metric is within the predetermined limit, summing those logical values together, and then evaluating the sum against a predetermined threshold. To further improve the evaluation method, a set of weights, Wᵢ, may be defined for each logical metric evaluation in order to rank their importance.

In the presently described embodiment, all three metrics, R₁, R₂, and Uₘ, are evaluated by way of the following equation:

D=W(R₁<L₁)+W₂(R₂<L₂)+W₃(Uₘ>L₃) (8)

Note that equation (8) is merely exemplary and other equations may be derived and used if so desired. If R₁ is within the limit of L1 (i.e., less than L1) then the evaluation of R₁ against L1 is set to a value 1; otherwise it is set to 0. This result is then multiplied by the weight W₁. If R₂ is within the limit of L2 (i.e., less than L2) then the evaluation of R₂ against L2 is set to a value 1; otherwise it is set to 0. This result is then multiplied by the weight W₂. If R₃ is within the limit of L3 (i.e., greater than L3) then the evaluation of R₃ against L3 is set to a value 1; otherwise it is set to 0. This result is then multiplied by the weight W₃. The summation of weighted metric evaluations is then compared against a predetermined threshold, T_{D}, which is proportional to the probability of producing a correct final decision. If D>T_{D}, the probability that IL<ILₘₐₓ is sufficiently high and therefore the splice joint is acceptable. Otherwise a failure indicator 204 can be activated, and the fiber is reterminated 408 and the splice is thereafter reevaluated 406, 407.

By way of an example, two test connectors shown in FIGS. 7J and 7H can be evaluated based on the metrics shown in FIGS. 9A-9C and the weights being set to W₁=60, W₂=20, W₃=30. For the connector of FIG. 7J, R₁=0.143, R₂=65.527, and Uₘ=1653.574. Plugging these values into equation (8) and evaluating against the data shown in FIGS. 9A-9C results in:

D=60(0.143<L1)+20(65.527<L2)+30(1653.574>L3) (9)

D=60(1)+20(0)+30(1) (10)

D=90 (11)

Thereafter, D is compared against the threshold T_{D} (which for the purposes of this example is assumed to be 80). Since (90>80) is true, the probability that IL is less than the maximum allowed IL is adequately high and therefore the splice joint is acceptable. Note that sole reliance on the R₂ metric would have eliminated this termination as acceptable even though the actual IL value is 0.26.

For connector of FIG. 7H, R₁=0.22, R₂=45.078, and Uₘ=1703.023. Plugging these values into equation (8) and evaluating against the data shown in FIGS. 9A-9C results in:

D=60(0.22<L1)+20(45.078<L2)+30(1703.023>L3) (12)

D=60(0)+20(0)+30(1) (13)

D=30 (14)

Thereafter, D is compared against the threshold T_{D}. Since (30>80) is false, the probability that IL is less than the maximum allowed IL is insufficiently low and therefore the splice joint is unacceptable. Note that sole reliance on the Uₘ metric would have deemed this termination acceptable even though the actual IL value is 0.58.

It should be noted that the aforementioned method can operate with one or more video cameras or additional imaging systems such as mirrors to capture images from opposite views of the connector splice joint. However, in some embodiments it may be preferable to use connectors with light-diffusing material. Therefore, one camera may be enough to provide an accurate estimation of the insertion loss based on the captured images.

A convenient and potentially cost effective embodiment of the present invention is to use a smartphone or other wireless device to control and view test results of the disclosed apparatus. The use of a personal handheld device may reduce the cost and size of the test apparatus by allowing at least a part of the application/use interface portion to run on the handheld device via an application which may be downloaded from an internet website. Furthermore, the handheld device may communicate with the test apparatus by means of Bluetooth, Wi-Fi, or other suitable wireless communication protocol.

In an embodiment, the makeup of the test apparatus can include a smartphone and an adapter. This can allow one to take advantage the hardware typically installed in the smartphone, using the smartphone's digital camera and digital processor for the digital camera and digital processor, respectively, of the test apparatus. In addition, an adapter having a light source therein can be connected to the phone. Such adapter may draw power directly from the smartphone and be activated by a test application executed on the smartphone. Such configuration may provide significant cost savings over a dedicated test apparatus and may be more desirable in some cases.

Note that while this invention has been described in terms of one or more embodiments, these embodiments are non-limiting (regardless of whether they have been labeled as exemplary or not), and there are alterations, permutations, and equivalents, which fall within the scope of this invention. For example, any number of zones of interest may be used for the evaluations of the splice joints and those zones may be defined in any way suitable for a particular application. Likewise, any number of metrics may be used to evaluate the properties of the splice, and those metrics may be defined by any suitable equation and/or relationship. Thus, while the described embodiments have presented a particular example of what is defined as any specific zone and any specific metric, those zones and metrics should not to be construed as limiting in any way. Additionally, the described embodiments should not be interpreted as mutually exclusive, and should instead be understood as potentially combinable if such combinations are permissive. It should also be noted that there are many alternative ways of implementing the methods and apparatuses of the present invention. It is therefore intended that claims that may follow be interpreted as including all such alterations, permutations, and equivalents as fall within the true spirit and scope of the present invention.

Furthermore, the subject matter described herein, such as for example the methods for testing the integrity of a splice joint in accordance with the present invention, can be implemented at least partially in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps of a method or process. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms. Devices embodying the subject matter described herein may be manufactured by any means, such as by semiconductor fabrication or discreet component assembly although other types of manufacturer are also acceptable, and can be manufactured of any material, e.g., CMOS.

We claim:

1. A method of installing a field fiber in a fiber optic connector having a stub fiber therein and/or evaluating at least one characteristic of a splice between said stub fiber and said field fiber, at least a portion of said fiber optic connector being at least one of transparent or translucent, said method comprising the steps of:
mating said fiber optic connector with a test apparatus;
injecting a light from a light source into said fiber optic connector via said stub fiber, some of said injected light radiating through said fiber optic connector;
subtracting background noise; and
using a digital camera to evaluate light radiating through said fiber optic connector to determine said at least one characteristic of said splice to evaluate a spatial pattern of said light radiating through said fiber optic connector through a stub fiber zone, a splice zone, and a field fiber zone.

2. The method of claim 1, wherein said digital camera is at least one of a digital photo camera and a digital video camera.

3. The method of claim 1, wherein said step of using said digital camera includes evaluating a spatial pattern of said light radiating through said fiber optic connector.

4. The method of claim 3, wherein said step of evaluating said spatial pattern includes analyzing light radiating through at least two zones of said fiber optic connector.

5. The method of claim 4, wherein said at least two zones include at least two of a stub fiber zone, a splice zone, and a field fiber zone.

6. The method of claim 1, wherein said step of evaluating said spatial pattern includes analyzing a geometry of said light radiating through said fiber optic connector.

7. The method of claim 1 further comprising the step of securing said field fiber within said fiber optic connector when an integrity of said splice is determined to be acceptable.

8. The method of claim 1, wherein said step of using said digital camera to determine said at least one characteristic of said splice includes the sub-steps of:
capturing a digital image of said fiber optic connector;
storing a relative intensity of at least some pixels of said digital image in a file;
defining each of said stub fiber zone, splice zone, and field fiber zone by a range of pixels;
converting each of said at least some pixels to bit level patterns to obtain a bit level image;
determining a metric for each of said stub fiber zone, splice zone, and field fiber zone; and
using at least one ratio of said respective metrics to render a decision on whether an insertion loss of said fiber optic connector exceeds a maximum allowed insertion loss.

9. The method of claim 8, wherein said decision on whether said insertion loss of said fiber optic connector exceeds said maximum allowed insertion loss is based on a statistical probability.

10. The method of claim 1, wherein said step of using said digital camera to determine said at least one characteristic of said splice further includes evaluating at least one of light radiating from said field fiber extending beyond said fiber optic connector and light radiating from an adapter that couples said light source to said fiber optic connector.
